(19) United States
(12) Patent Application Publication
(10) Pub. No.: US 2025/0343292 A1
(43) Pub. Date: Nov. 6, 2025

(54) ENERGY STORAGE APPARATUS, MANAGEMENT APPARATUS, TEMPERATURE ESTIMATION METHOD FOR ENERGY STORAGE DEVICE, AND COMPUTER PROGRAM

(71) Applicant: GS Yuasa International Ltd., Kyoto-shi (JP)

(72) Inventors: Akihito UMEDA, Kyoto-shi (JP); Takeyuki SHIRAISHI, Kyoto-shi (JP); Yuichiro YAMAMOTO, Kyoto-shi (JP); Yuki IMANAKA, Kyoto-shi (JP)

(21) Appl. No.: 19/266,218

(22) Filed: Jul. 11, 2025

Related U.S. Application Data
(63) Continuation of application No. PCT/JP2023/043380, filed on Dec. 5, 2023.

(30) Foreign Application Priority Data
Jan. 19, 2023 (JP) 2023-006812

(51) Int. Cl. H01M 10/633; H01G 11/18; H01M 10/42; H01M 10/48; H01M 10/647; H01M 10/6554; H01M 10/6571; H01M 50/209

(52) U.S. Cl. CPC H01M 10/633; H01M 10/425; H01M 10/486; H01M 10/647; H01M 10/6554; H01M 10/6571; H01M 50/209; H01G 11/18; H01M 2010/4271

(57) ABSTRACT

An energy storage apparatus includes an energy storage device, a circuit board being thermally separated from the energy storage device, a heat transfer structure made of metal to transfer heat of the energy storage device to the circuit board, a temperature sensor provided on the circuit board to be electrically insulated from a coupling site on the circuit board to which the heat transfer structure is coupled to measure a temperature of the coupling site, and an arithmetic device including a processor and a memory, the memory including a program that is executable by the processor to estimate a temperature of the energy storage device based on the temperature of the coupling site measured by the temperature sensor.

### CROSS REFERENCE TO RELATED APPLICATIONS

This application claims the benefit of priority to Japanese Patent Application No. 2023-006812 filed on Jan. 19, 2023 and is a Continuation Application of PCT Application No. PCT/JP2023/043380 filed on Dec. 5, 2023. The entire contents of each application are hereby incorporated herein by reference.

### BACKGROUND OF THE INVENTION

### 1. Field of the Invention

The present invention relates to energy storage apparatuses, management apparatuses, temperature estimation methods for energy storage devices, and non-transitory computer-readable media including computer programs.

### 2. Description of the Related Art

In order to safely use an energy storage apparatus including an energy storage device and to exhibit its performance to the maximum, it is important to accurately detect a temperature inside the energy storage device.

Conventionally, a temperature of a case top surface of an energy storage device is measured and used as a substitute for a temperature inside the energy storage device (for example, refer to Japanese Unexamined Patent Application Publication No. 2017-59503).

### SUMMARY OF THE INVENTION

However, it is difficult to attach a temperature sensor to a case of the energy storage device, and a special attachment structure is often required.

Example embodiments of the present invention provide energy storage apparatuses each capable of estimating a temperature of an energy storage device by using a temperature sensor provided on a circuit board, management apparatuses, temperature estimation methods for energy storage devices, and non-transitory computer-readable media including computer programs.

An energy storage apparatus according to an example embodiment of the present invention includes an energy storage device, a circuit board thermally separated from the energy storage device, a heat transfer structure made of metal to transfer heat of the energy storage device to the circuit board, a first temperature sensor provided on the circuit board to be electrically insulated from a coupling site on the circuit board to which the heat transfer structure is coupled and to measure a temperature of the coupling site, and an arithmetic device including a processor and a memory, the memory including a program that is executable by the processor to cause the processor to estimate a temperature of the energy storage device based on the temperature of the coupling site measured by the first temperature sensor.

According to example embodiments of the present invention, a temperature of an energy storage device can be estimated by using a temperature sensor provided on a circuit board.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a configuration of an energy storage apparatus according to an example embodiment of the present invention.

FIG. 2 is an exploded perspective view of an energy storage apparatus.

FIG. 3 is a plan view illustrating an arrangement of a bus bar.

FIG. 4 is an exploded perspective view illustrating an arrangement of a bus bar.

FIG. 5 is a plan view illustrating a configuration of a circuit board.

FIG. 6 is a block diagram illustrating an internal configuration of a management apparatus.

FIG. 7 is a graph illustrating time transition of a board temperature or a cell internal temperature when an environmental temperature is steeply changed.

FIG. 8 is a circuit diagram representing a thermal circuit model of the energy storage apparatus.

FIG. 9 is a graph illustrating a temporal change in ratio.

FIG. 10 is a flowchart illustrating a procedure of processing to be executed by a management apparatus according to a first example embodiment of the present invention.

FIG. 11 is a graph illustrating an estimation result in the first example embodiment of the present invention.

FIG. 12 is an explanatory view illustrating an arrangement of a first temperature sensor in a second example embodiment of the present invention.

FIG. 13 is a graph illustrating an estimation result in the second example embodiment of the present invention.

FIG. 14 is an explanatory view illustrating a timing of switching between a temperature gradient method and a Joule heating method.

FIG. 15 is a flowchart illustrating a procedure of processing to be executed by a management apparatus according to a third example embodiment of the present invention.

### DETAILED DESCRIPTION OF THE EXAMPLE EMBODIMENTS

(1) An energy storage apparatus according to an example embodiment of the present disclosure includes an energy storage device, a circuit board thermally separated from the energy storage device, a heat transfer structure made of metal to transfer heat of the energy storage device to the circuit board, a first temperature sensor provided on the circuit board to be electrically insulated from a coupling site on the circuit board to which the heat transfer structure is coupled and to measure a temperature of the coupling site, and an arithmetic device including a processor and a memory, the memory including a program that is executable by the processor to cause the processor to estimate a temperature of the energy storage device based on the temperature of the coupling site measured by the first temperature sensor.

In the present specification, “a circuit board thermally separated from the energy storage device” or “a circuit board disposed to be thermally isolated from an energy storage device” means that a metallic structure other than a heat transfer structure or a structure having high thermal conductivity does not directly couple the energy storage device and the circuit board, so that thermal conduction between the energy storage device and the circuit board is intensively performed by the metallic heat transfer structure.

According to the energy storage apparatus of the above (1), as compared with a case where the temperature sensor is attached to a surface of the energy storage device, the temperature sensor can be easily attached to the circuit board (mounted on wiring of the circuit board), and no special attachment structure is required.

A small and inexpensive chip thermistor or the like can be used as the temperature sensor provided on the circuit board, which can contribute to miniaturization and cost reduction of the energy storage apparatus.

The heat transfer structure made of metal, which couples the energy storage device and the circuit board, has thermal resistance (difficulty in heat transfer) depending on the shape and material thereof. By using the heat transfer structure, the temperature of the energy storage device can be estimated from the temperature of a site (for example, the coupling site) away from the energy storage device. Accordingly, a degree of freedom in designing the circuit board and the energy storage apparatus can be improved, and a design of the energy storage apparatus suitable for mass production can be adopted.

(2) In the energy storage apparatus according to the above (1), it is preferable that a bus bar defining a charge/discharge path of the energy storage device is further included, and the heat transfer structure is integral with the bus bar.

The bus bar, which is provided close to the energy storage device to constitute the charge/discharge path, is made of metal, and therefore has good heat transfer characteristics, and exhibits a temperature behavior similar to the internal temperature behavior of the energy storage device. By causing such a bus bar to function as a part of the heat transfer structure, accuracy of temperature estimation of the energy storage device can be improved. Compared to a case in which the temperature sensor is attached to the bus bar, the temperature sensor can be easily attached to the circuit board.

(3) In the energy storage apparatus according to the above (1) or (2), it is preferable that the heat transfer structure has a smaller cross-sectional area than that of the bus bar, and extends from the bus bar toward the circuit board.

The heat of the energy storage device can be transferred by the heat transfer structure which has a smaller cross-sectional area than that of the bus bar and is formed to rise (to traverse a heat insulating layer) toward the circuit board disposed to be thermally isolated from the energy storage device. Since the heat transfer structure has a smaller cross-sectional area than that of the bus bar, heat of the heat transfer structure does not easily dissipate into the surrounding air. When the cross-sectional area is extremely small, the thermal resistance in the heat transfer structure increases, and the heat transfer properties deteriorate. Therefore, the heat transfer structure is formed to have an appropriate thickness and width capable of ensuring heat transfer properties while suppressing heat dissipation. By providing a heat insulating layer such as air between the circuit board and the energy storage device, it is possible to restrain components other than the temperature sensor on the circuit board from being affected by heat of the energy storage device and the bus bar.

(4) In the energy storage apparatus according to any one of the above (1) to (3), it is preferable that the energy storage apparatus includes a plurality of energy storage devices electrically connected to each other by the bus bar, and the heat transfer structure is configured to transfer heat of the plurality of energy storage devices to the circuit board.

The plurality of energy storage devices electrically connected by the bus bar exhibit similar temperature behaviors in many cases. In the energy storage apparatus according to the above (4), heat (representative heat) of the plurality of energy storage devices is transferred to the coupling site on the circuit board by, for example, one heat transfer structure (the number of which is smaller than the number of energy storage devices), and temperatures of the plurality of energy storage devices are estimated based on a temperature of the coupling site. In this way, it is possible to estimate the heat of the plurality of energy storage devices while reasonably reducing the number of temperature sensors, which can contribute to cost reduction of the energy storage apparatus.

(5) In the energy storage apparatus according to any one of the above (1) to (4), it is preferable that the arithmetic device is configured or programmed to estimate the temperature of the energy storage device by switching between a first method based on the temperature of the coupling site and a second method based on a current that flows through the energy storage device.

In the method using heat transfer by the heat transfer structure, the accuracy of temperature estimation of the energy storage device may decrease. For example, when the current that flows through the energy storage device is large, the accuracy of temperature estimation tends to decrease in the above-described method. In such a case, by performing temperature estimation by switching to the second method, the accuracy of temperature estimation can be improved.

(6) A management apparatus according to an example embodiment of the present disclosure includes a processor, a memory including a program executable by the processor to function as an acquisition section configured or programmed to acquire, from a temperature sensor, temperature data of a coupling site on a circuit board to which a heat transfer structure is coupled, the circuit board being thermally separated from an energy storage device, the transfer structure being configured to transfer heat of the energy storage device to the circuit board, the temperature sensor being provided on the circuit board to be electrically insulated from the coupling site and to measure a temperature of the coupling site, and an estimation section configured or programmed to estimate the temperature of the energy storage device based on acquired temperature data.

According to the management apparatus of the above (6), the temperature of the energy storage device can be estimated by using the temperature sensor provided on the circuit board.

(7) A temperature estimation method for an energy storage device according to an example embodiment of the present disclosure causes a computer to perform processing including acquiring, from a temperature sensor, temperature data of a coupling site on a circuit board to which a heat transfer structure is coupled, the circuit board being thermally separated from an energy storage device, the heat transfer structure transferring heat of the energy storage device to the circuit board, the temperature sensor being provided on the circuit board to be electrically insulated from the coupling site and to measure a temperature of the coupling site, and estimating a temperature of the energy storage device based on the temperature data acquired in the acquiring.

According to the temperature estimation method for an energy storage device in the above (7), the temperature of the energy storage device can be estimated by using the temperature sensor provided on the circuit board.

(8) A non-transitory computer-readable medium includes a computer program executable to cause a computer to perform processing including acquiring, from a temperature sensor, temperature data of a coupling site on a circuit board to which a heat transfer structure is coupled, the circuit board being thermally separated from an energy storage device, the heat transfer structure transferring heat of the energy storage device to the circuit board, the temperature sensor being provided on the circuit board to be electrically insulated from the coupling site and to measure a temperature of the coupling site, and estimating a temperature of the energy storage device based on the temperature data acquired in the acquiring.

According to the non-transitory computer-readable medium including a computer program of the above (8), the temperature of the energy storage device can be estimated by using the temperature sensor provided on the circuit board.

Hereinafter, the present invention will be specifically described based on the drawings illustrating example embodiments thereof.

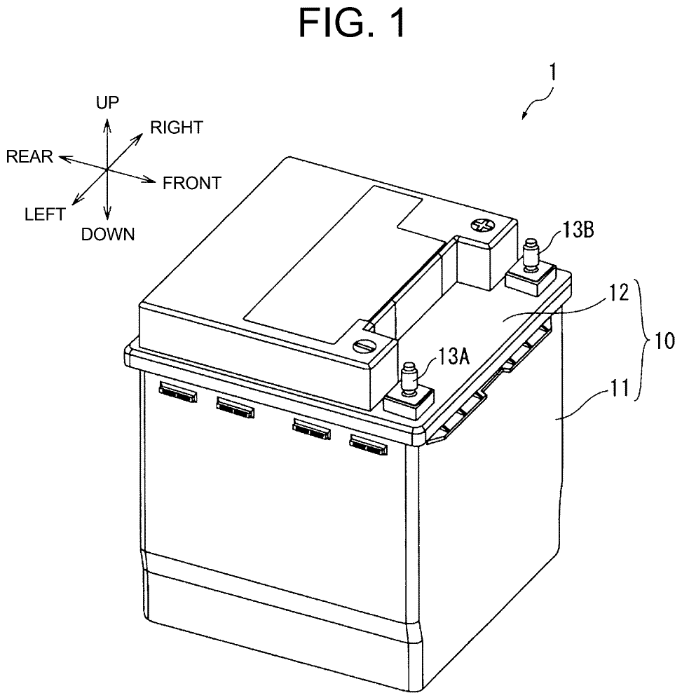

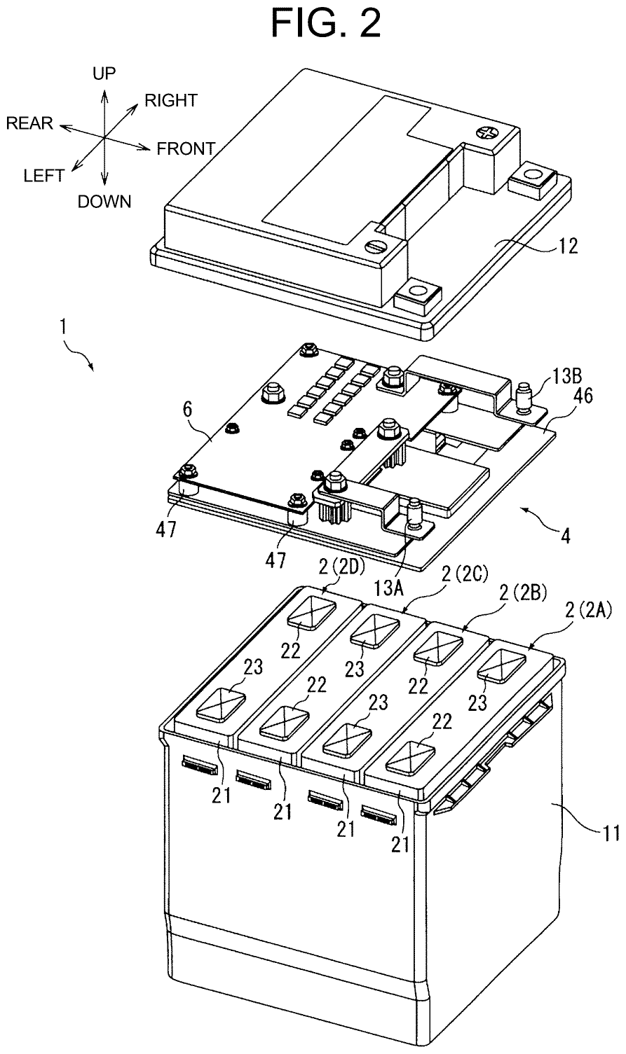

FIG. 1 is a perspective view illustrating a configuration example of an energy storage apparatus 1 according to an example embodiment, and FIG. 2 is an exploded perspective view of the energy storage apparatus 1. Hereinafter, a configuration example of the energy storage apparatus 1 will be described with reference to each direction of “front-rear”, “left-right”, and “up-down” illustrated in the drawings.

The energy storage apparatus 1 is, for example, a battery which is suitably mounted on a vehicle such as an engine vehicle, an electric vehicle (EV), a hybrid electric vehicle (HEV), or a plug-in hybrid electric vehicle (PHEV), or any other mobile object.

The energy storage apparatus 1 includes an energy storage device 2, a bus bar unit 4, and a circuit board 6. The energy storage device 2, the bus bar unit 4, and the circuit board 6 are housed inside a housing case 10. The housing case 10 is made of synthetic resin. The housing case 10 includes: a case main-body 11 with an upper surface opened; and a cover 12 covering the opening of the case main-body 11. Dimensions of the case main-body 11 and the cover 12 are designed in accordance with dimensions and the number of energy storage devices 2 to be housed therein. The case main-body 11 and the cover 12 are liquid-tightly fixed to each other by means of a fastener such as a screw; an adhesive; welding; or the like, in a state in which the energy storage device 2, the bus bar unit 4, and the circuit board 6 are housed therein.

The energy storage device 2 is, for example, a battery cell utilizing a lithium-ion secondary battery. The energy storage device 2 includes a case 21 having a hollow rectangular parallelepiped shape. A positive terminal 22 and a negative terminal 23 of the energy storage device 2 are provided on an upper surface of the case 21. An electrode body, an electrolyte solution, and the like are housed inside the case 21.

Although not illustrated in detail, the electrode body is configured by stacking sheet-shaped positive and negative electrodes with two sheet-shaped separators interposed therebetween, and winding (vertically winding or horizontally winding) these. The separator is formed of a porous resin film. As the porous resin film, a porous resin film made of a resin such as polyethylene (PE) or polypropylene (PP) can be used.

The positive electrode is an electrode plate in which a positive electrode active material layer is formed on a surface of a long band-shaped positive electrode substrate made of, for example, aluminum, an aluminum alloy, or the like. The positive electrode active material layer includes a positive electrode active material. A material capable of absorbing and releasing lithium ions can be used as the positive electrode active material used in the positive electrode active material layer. Examples of the positive electrode active material include LiFePO₄. The positive electrode active material layer may further include a conductive auxiliary agent, a binder, and the like.

The negative electrode is an electrode plate in which a negative electrode active material layer is formed on a surface of a long band-shaped negative electrode substrate made of, for example, copper or a copper alloy. The negative electrode active material layer includes a negative electrode active material. As the negative electrode active material, a material capable of absorbing and releasing lithium ions can be used. Examples of the negative electrode active material include graphite, hard carbon, and soft carbon. The negative electrode active material layer may further include a binder, a thickener, and the like.

As the electrolyte, an electrolyte similar to that of a conventional lithium-ion secondary battery can be used. For example, as the electrolyte, an electrolyte in which a supporting salt is contained in an organic solvent can be used. As the organic solvent, for example, an aprotic solvent such as carbonates, esters, or ethers is used. As the supporting salt, for example, a lithium salt such as LiPF₆, LiBF₄, or LiClO₄ is suitably used. The electrolyte may include, for example, various additives such as a gas generating agent, a coating film forming agent, a dispersing agent, and a thickener.

In the present example embodiment, the energy storage device 2 is a battery cell utilizing a lithium-ion secondary battery. Alternatively, the energy storage device 2 may be a battery cell such as an all-solid-state battery, a lead battery, a redox flow battery, a zinc-air battery, an alkaline manganese battery, a lithium-sulfur battery, a sodium-sulfur battery, a silver oxide-zinc battery, a nickel-hydrogen battery, or a molten salt thermal battery, or may be a capacitor.

In the present example embodiment, the energy storage device 2 is a rectangular battery cell including a wound electrode body. Alternatively, the energy storage device 2 may be a cylindrical battery cell or a laminated (pouch-shaped) battery cell, or may be a battery cell provided with a laminated electrode body.

In the present example embodiment, the number of energy storage devices 2 housed in the case main-body 11 is four. Alternatively, the number of the energy storage devices 2 housed in the case main-body 11 may be greater than or equal to one and less than four, or may be greater than four.

In the following description, the energy storage devices 2 are also referred to as a first energy storage device 2A, a second energy storage device 2B, a third energy storage device 2C, and a fourth energy storage device 2D in this order from the front side of the case main-body 11. That is, the second energy storage device 2B is disposed adjacent to a rear surface of the first energy storage device 2A, the third energy storage device 2C is disposed adjacent to a rear surface of the second energy storage device 2B, and the fourth energy storage device 2D is disposed adjacent to a rear surface of the third energy storage device 2C. In the example of FIG. 2, the first energy storage device 2A and the third energy storage device 2C are housed in the case main-body 11 in an orientation with the positive terminal 22 on the left and the negative terminal 23 on the right, and the second energy storage device 2B and the fourth energy storage device 2D are housed in the case main-body 11 in an orientation with the positive terminal 22 on the right and the negative terminal 23 on the left.

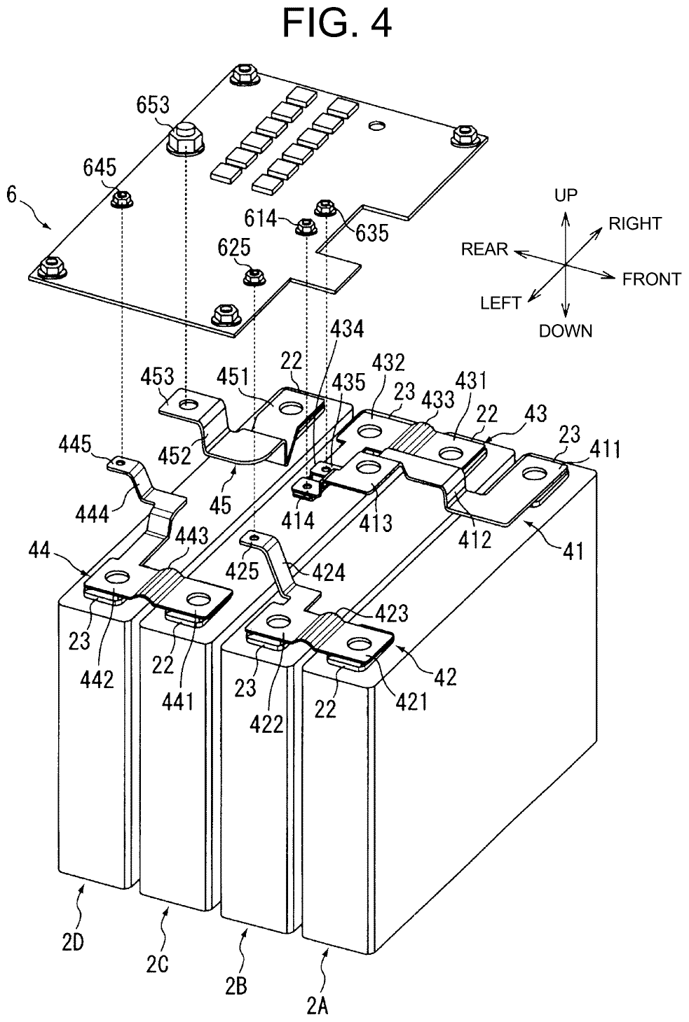

The bus bar unit 4 is disposed on a terminal surface of the energy storage device 2. The bus bar unit 4 includes: a plurality of bus bars 41 to 45 (refer to FIG. 4); and a bus bar frame 46 made of resin and holding these bus bars 41 to 45. The bus bar frame 46 covers upper sides of the plurality of energy storage devices 2 and blocks radiant heat emitted from the plurality of energy storage devices 2. The circuit board 6 is disposed on an upper surface of the bus bar frame 46. The circuit board 6 is fixed to the bus bar frame 46 via the spacer 47 in a state of being separated from the upper surface of the bus bar frame 46. Since the bus bar frame 46 or a heat insulating layer such as air exists between the circuit board 6 and the energy storage devices 2, the circuit board 6 is disposed to be thermally separated from the energy storage devices 2. In the present example embodiment, the metal structures that directly couple the circuit board 6 and the energy storage devices 2 are only the bus bars 41 to 45. The bus bars 41 to 45 are exposed to air forming a heat insulating layer between the circuit board 6 and the energy storage devices 2, and are not covered with resin or the like, except for portions insert-molded in the bus bar frame 46. Therefore, heat does not easily dissipate from the bus bars 41 to 45 via the resin structure.

The bus bars 41 to 45 included in the bus bar unit 4 constitute a charge/discharge path for the energy storage devices 2. The bus bars 41 to 45 are made of metal, and are formed of a material having excellent conductivity and high thermal conductivity, such as aluminum, an aluminum alloy, copper, a copper alloy, or stainless steel.

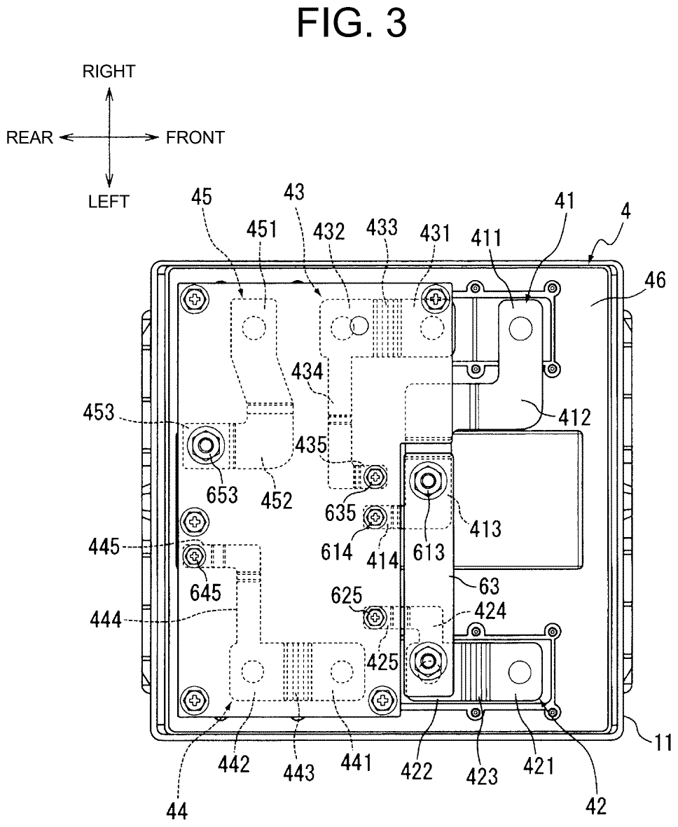

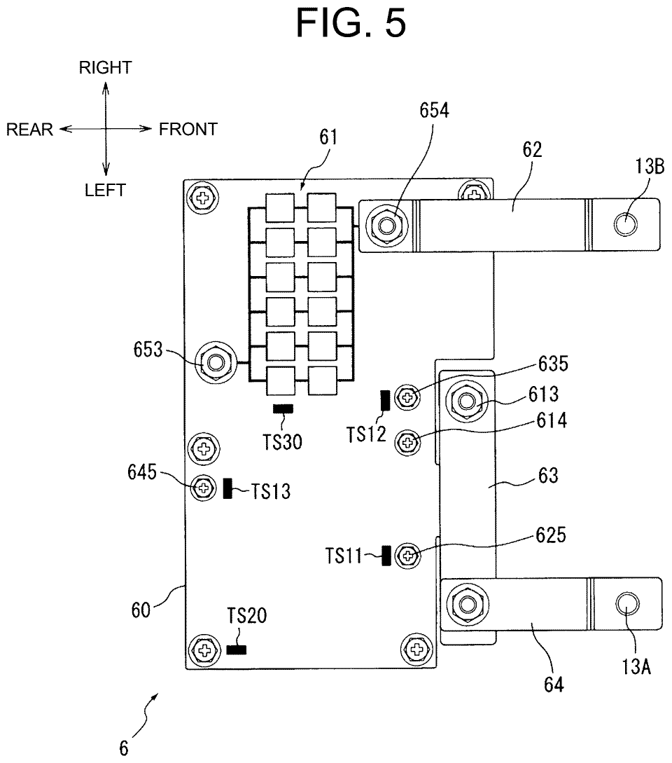

Hereinafter, an arrangement of the bus bars 41 to 45 will be described. FIG. 3 is a plan view illustrating an arrangement of the bus bars 41 to 45, and FIG. 4 is an exploded perspective view illustrating an arrangement of the bus bars 41 to 45. In FIGS. 3 and 4, some components are removed for the sake of description. The bus bar 41 is a structure for connecting the negative terminal 23 of the first energy storage device 2A to one external terminal 13A. The bus bar 41 includes a base portion 411, a bent portion 412, a first coupling portion 413, and a second coupling portion 414. The base portion 411 is joined to the negative terminal 23 of the first energy storage device 2A. An existing method such as welding is used for the joining. The bent portion 412 is a structure rising from the same plane as that of the base portion 411 to a height position of a conductor 63, and connects the base portion 411 and the first coupling portion 413. The first coupling portion 413 is coupled to one end of the conductor 63 by a fastener 613 such as a screw. The conductor 63 is a flat plate-shaped structure having excellent conductivity, such as aluminum, an aluminum alloy, copper, a copper alloy, or stainless steel. The other end of the conductors 63 is connected to the external terminal 13A via a bus bar 64 (refer to FIG. 5). The conductor 63 is disposed as a shunt resistor for detecting a current that flows through the external terminal 13A. The second coupling portion 414 is a structure continuous to a rear end of the first coupling portion 413, and is coupled to a lower surface of the circuit board 6 by a fastener 614 such as a screw. The second coupling portion 414 coupled to the circuit board 6 is narrow in width in plan view, and has a smaller cross-sectional area than other portions of the bus bar 41 (portions constituting a charge/discharge path (power line)).

The bus bar 42 electrically connects the positive terminal 22 of the first energy storage device 2A and the negative terminal 23 of the second energy storage device 2B. The bus bar 42 includes a first base portion 421, a second base portion 422, a curved portion 423, a bent portion 424, and a coupling portion 425. The first base portion 421 is joined to the positive terminal 22 of the first energy storage device 2A. The second base portion 422 is joined to the negative terminal 23 of the second energy storage device 2B. An existing method such as welding is used for the joining. The curved portion 423 is a semi-annular structure curved upward. The curved portion 423 is provided to allow a difference in height of the energy storage device 2 due to manufacturing variations, and to maintain electrical connection between the terminals. The bent portion 424 is a structure rising from the same plane as that of the second base portion 422 to a height position of the circuit board 6, and connects the second base portion 422 and the coupling portion 425. The coupling portion 425 is coupled to the lower surface of the circuit board 6 by a fastener 625 such as a screw. The coupling portion 425 and the bent portion 424, which are coupled to the circuit board 6, are narrow in width in plan view, and have a smaller cross-sectional area than other portions of the bus bar 42 (portions constituting a charge/discharge path (power line)). Heat on the circuit board 6 is transferred to the second energy storage device 2B and the first energy storage device 2A via the fastener 625 and the bus bar 42. Heat that is generated in the first energy storage device 2A and the second energy storage device 2B during charge and discharge is transferred to an upper surface of the circuit board 6 via the bus bar 42 and the fastener 625.

The bus bar 43 electrically connects the positive terminal 22 of the second energy storage device 2B and the negative terminal 23 of the third energy storage device 2C. The bus bar 43 includes a first base portion 431, a second base portion 432, a curved portion 433, a bent portion 434, and a coupling portion 435. The first base portion 431 is joined to the positive terminal 22 of the second energy storage device 2B. The second base portion 432 is joined to the negative terminal 23 of the third energy storage device 2C. An existing method such as welding is used for the joining. The curved portion 433 is a semi-annular structure curved upward. The curved portion 433 is provided to allow a difference in height of the energy storage device 2 due to manufacturing variations, and to maintain electrical connection between the terminals. The bent portion 434 has a portion rising from the same plane as that of the second base portion 432 to a height position of the circuit board 6, and is a structure that connects the second base portion 432 and the coupling portion 435. The coupling portion 435 is coupled to the lower surface of the circuit board 6 by a fastener 635 such as a screw. The coupling portion 435 and the bent portion 434 circuit board, which are coupled to the circuit board 6, are narrow in width in plan view, and have a smaller cross-sectional area than other portions of the bus bar 43 (portions constituting a charge/discharge path (power line)). Heat on the circuit board 6 is transferred to the third energy storage device 2C and the second energy storage device 2B via the fastener 635 and the bus bar 43. Heat that is generated in the second energy storage device 2B and the third energy storage device 2C during charge and discharge is transferred to the upper surface of the circuit board 6 via the bus bar 43 and the fastener 635.

The bus bar 44 electrically connects the positive terminal 22 of the third energy storage device 2C and the negative terminal 23 of the fourth energy storage device 2D. The bus bar 44 includes a first base portion 441, a second base portion 442, a curved portion 443, a bent portion 444, and a coupling portion 445. The first base portion 441 is joined to the positive terminal 22 of the third energy storage device 2C. The second base portion 442 is joined to the negative terminal 23 of the fourth energy storage device 2D. An existing method such as welding is used for the joining. The curved portion 443 is a semi-annular structure curved upward. The curved portion 443 is provided to allow a difference in height of the energy storage device 2 due to manufacturing variations, and to maintain electrical connection between the terminals. The bent portion 444 is a structure rising from the same plane as that of the second base portion 442 to a height position of the circuit board 6, and connects the second base portion 442 and the coupling portion 445. The coupling portion 445 is coupled to the lower surface of the circuit board 6 by a fastener 645 such as a screw. The coupling portion 445 and the bent portion 444, which are coupled to the circuit board 6, are narrow in width in plan view, and have a smaller cross-sectional area than other portions of the bus bar 44 (portions constituting a charge/discharge path (power line)). Heat on the circuit board 6 is transferred to the fourth energy storage device 2D and the third energy storage device 2C via the fastener 645 and the bus bar 44. Heat that is generated in the third energy storage device 2C and the fourth energy storage device 2D during charge and discharge is transferred to the upper surface of the circuit board 6 via the bus bar 44 and the fastener 645.

The bus bar 45 is a structure for connecting the positive terminal 22 of the fourth energy storage device 2D to an other external terminal 13B. The bus bar 45 includes a base portion 451, a bent portion 452, and a coupling portion 453. The base portion 451 is joined to the positive terminal 22 of the fourth energy storage device 2D. An existing method such as welding is used for the joining. The bent portion 452 is a structure rising from the same plane as that of the base portion 451 to a height position of the circuit board 6, and connects the base portion 451 and the coupling portion 453. The coupling portion 453 is coupled to the lower surface of the circuit board 6 by a fastener 653 such as a screw.

In FIGS. 3 and 4, the four energy storage devices 2 are connected in series by the bus bars 41 to 45. Alternatively, some or all of the energy storage devices 2 may be connected in parallel.

Hereinafter, a configuration of the circuit board 6 will be described.

FIG. 5 is a plan view illustrating a configuration of the circuit board 6. The circuit board 6 includes a board 60 made of resin and a blocking circuit 61 disposed on an upper surface of the board 60.

The blocking circuit 61 is a circuit for connecting or disconnecting a conduction path between the bus bar 45 connected to the positive terminal 22 of the fourth energy storage device 2D and the bus bar 62 connected to the external terminal 13B. The bus bar 62 is a flat plate-shaped conductive structure extending in a front-rear direction. A rear end of the bus bar 62 is fixed to the upper surface of the board 60 by a fastener 654 such as a screw, and the external terminal 13B is connected to a front end of the bus bar 62. The conduction path between the bus bars 45 and 62 is wiring which is made of a conductive material such as copper or a copper alloy, is formed on the upper surface of the board 60 or inside the board 60, and has one end electrically connected to the bus bar 45 and the other end electrically connected to the bus bar 62.

The blocking circuit 61 is constituted by, for example, a semiconductor switch such as a metal oxide semiconductor field effect transistor (MOSFET). In the example of FIG. 5, six conduction paths extending in the front-rear direction are formed as the conduction paths between the bus bars 45 and 62, and two MOSFETs are connected in series to each of the six conduction paths (and the internal body diodes are connected in the reverse direction). The two MOSFETs disposed in each conduction path have a function as a switch to connect or block the conduction path, and have a function to prevent a current from flowing out from the energy storage device 2 to the outside and a current from flowing into the energy storage device 2 from the outside when the conduction path is blocked. Alternatively, the blocking circuit 61 may be constituted by a relay switch.

The circuit board 6 further includes first temperature sensors TS11 to TS13, a second temperature sensor TS20, and a third temperature sensor TS30.

The first temperature sensor TS11 is disposed in a vicinity of the fastener 625, and measures the temperature of a coupling site on the circuit board 6 to which the bus bar 42 is coupled. The vicinity of the fastener 625 represents a position at which heat of the first energy storage device 2A and the second energy storage device 2B is transferred via the bus bar 42 and is detected as a temperature change on the upper surface of the circuit board 6. The first temperature sensor TS11 is disposed, as a position in the vicinity of the fastener 625, at a position on the circuit board 6 having a difference in temperature within an allowable range from the temperatures of the first energy storage device 2A and the second energy storage device 2B. The first temperature sensor TS11 is a temperature sensor such as a chip thermistor in which a periphery of a sensor portion is insulated by a synthetic resin material or the like.

The first temperature sensor TS12 is disposed in a vicinity of the fastener 635, and measures the temperature of a coupling site on the circuit board 6 to which the bus bar 43 is coupled. The vicinity of the fastener 635 represents a position at which heat of the second energy storage device 2B and the third energy storage device 2C is transferred via the bus bar 43 and is detected as a temperature change on the upper surface of the circuit board 6. The first temperature sensor TS12 is disposed, as a position in the vicinity of the fastener 635, at a position on the circuit board 6 having a difference in temperature within an allowable range from the temperatures of the first energy storage device 2A and the second energy storage device 2B. The first temperature sensor TS12 is a temperature sensor, such as a thermistor or a thermocouple, in which a periphery of a sensor portion is insulated by a synthetic resin material or the like.

The first temperature sensor TS13 is disposed in a vicinity of the fastener 645, and measures the temperature of a coupling site on the circuit board 6 to which the bus bar 44 is coupled. The vicinity of the fastener 645 represents a position at which heat of the third energy storage device 2C and the fourth energy storage device 2D is transferred via the bus bar 44, and is detected as a temperature change on the upper surface of the circuit board 6. The first temperature sensor TS13 is disposed, as a position in the vicinity of the fastener 645, at a position on the circuit board 6 having a difference in temperature within an allowable range from the temperatures of the third energy storage device 2C and the fourth energy storage device 2D. The first temperature sensor TS13 is a temperature sensor, such as a thermistor or a thermocouple, in which a periphery of a sensor portion is insulated by a synthetic resin material or the like.

The second temperature sensor TS20 measures an ambient temperature of the circuit board 6. The ambient temperature of the circuit board 6 represents a temperature of a space (air) in which the circuit board 6 is installed. The second temperature sensor TS20 is disposed at a position sufficiently separated from the energy storage device 2, the blocking circuit 61, and the like, in such a way as not to be affected by heat from heat generating components including the energy storage device 2. For example, the second temperature sensor TS20 is disposed at a position separated from the fasteners 614, 625, and 645 on the upper surface of the circuit board 6. Alternatively, the second temperature sensor TS20 may be disposed on the cover 12 of the housing case 10, or may be disposed on the bus bar frame 46. The second temperature sensor TS20 is a temperature sensor, such as a thermistor or a thermocouple, in which a periphery of a sensor portion is insulated by a synthetic resin material or the like.

The third temperature sensor TS30 measures a temperature of a heat generating component on the circuit board 6. In the example of FIG. 5, the heat generating component is a semiconductor switch included in the blocking circuit 61. For example, when the energy storage device 2 is charged and discharged at a high rate, heat generation of the semiconductor switch becomes large. The third temperature sensor TS30 is disposed in a vicinity of the heat generating component. The vicinity of the heat generating component represents a position to which heat of the heat generating component is transferred and which is detected as a temperature change on the upper surface of the board of the circuit board 6. The third temperature sensor TS30 is a temperature sensor, such as a thermistor or a thermocouple, in which a periphery of a sensor portion is insulated by a synthetic resin material or the like.

When a balancer, which balances charge states (voltages) of the plurality of energy storage devices 2, is mounted on the circuit board 6, the third temperature sensor TS30 may be disposed in a vicinity of the balancer (an other example of the heat generating component).

The circuit board 6 may further include a connector for communication. A communication cable conforming to a communication standard such as Controller Area Network (CAN) or Local Interconnect Network (LIN) is connected to the connector. The circuit board 6 communicates with an external device such as a vehicle electronic control unit (ECU) via a communication cable connected to the connector, and receives a command from the external device or transmits necessary data to the external device.

Hereinafter, the management apparatus 100 of the energy storage apparatus 1 will be described.

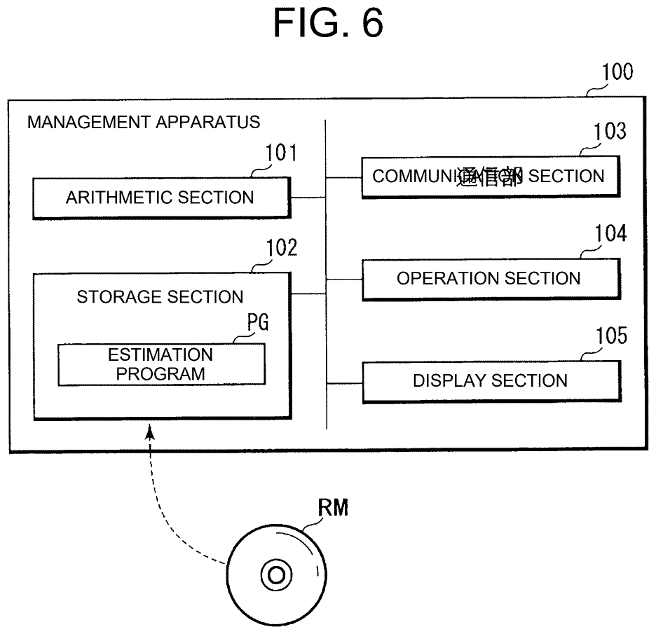

FIG. 6 is a block diagram illustrating an internal configuration of the management apparatus 100. The management apparatus 100 is, for example, a battery management unit (BMU) mounted inside the energy storage apparatus 1. Alternatively, the management apparatus 100 may be a computer, such as a terminal apparatus or a server apparatus, connected to the outside of the energy storage apparatus 1. The management apparatus 100 includes an arithmetic section 101, a storage section 102, a communication section 103, an operation section 104, a display section 105, and the like.

The arithmetic section 101 is an arithmetic circuit including, for example, a central processing unit (CPU), a read only memory (ROM), a random access memory (RAM), and the like. The CPU included in the arithmetic section 101 reads and executes various computer programs stored in the ROM or the storage section 102, and causes the entire apparatus to function as an arithmetic device that estimates a temperature of the energy storage device 2. In the present example embodiment, the arithmetic section 101 estimates the temperature of the energy storage device 2, based on the temperatures of the coupling sites measured by the first temperature sensors TS11 to TS13.

Alternatively, the arithmetic section 101 may be any arithmetic circuit including a plurality of CPUs, a multi-core CPU, a graphics processing unit (GPU), a microcomputer, a volatile or non-volatile memory, or the like. The arithmetic section 101 may have functions of a timer that measures an elapsed time from when a measurement start instruction is given to when a measurement end instruction is given, a counter that counts the number, a clock that outputs date and time information, and the like.

The storage section 102 includes a storage device such as a flash memory or a hard disk. The storage section 102 stores therein various computer programs and data. The computer programs stored in the storage section 102 include an estimation program PG for causing a computer to execute processing of estimating the temperature of the energy storage device 2, based on the temperatures of the coupling sites measured by the first temperature sensors TS11 to TS13. The data stored in the storage section 102 includes parameters used in the estimation program PG, data generated by the arithmetic section 101, and the like.

A computer program including the estimation program PG is provided by a non-transitory recording medium RM in which the computer program is recorded in a readable manner. The recording medium RM is a portable memory such as a CD-ROM, a USB memory, or a secure digital (SD) card. The arithmetic section 101 reads a desired computer program from the recording medium RM by using a reading device (not illustrated), and stores the read computer program in the storage section 102. Alternatively, the above-described computer program may be provided by communication.

The communication section 103 includes a communication interface that communicates with the circuit board 6. The communication section 103 receives, from the circuit board 6, temperature data measured by the first temperature sensors TS11 to TS13, temperature data measured by the second temperature sensor TS20, temperature data measured by the third temperature sensor TS30, and the like. The communication section 103 outputs the temperature data received from the circuit board 6 to the arithmetic section 101. The arithmetic section 101 stores the temperature data acquired through the communication section 103 in, for example, the storage section 102.

The operation section 104 includes input devices such as various switches and buttons, and accepts an operation by a user. The display section 105 includes a display device such as a liquid crystal display device, and displays information to be notified to the user. Alternatively, the management apparatus 100 may be configured to receive a necessary operation through an external computer, and transmit information to be notified to the user to an external computer. In this case, the operation section 104 and the display section 105 may not be mounted on the management apparatus 100.

Hereinafter, a temperature estimation method by the management apparatus 100 will be described.

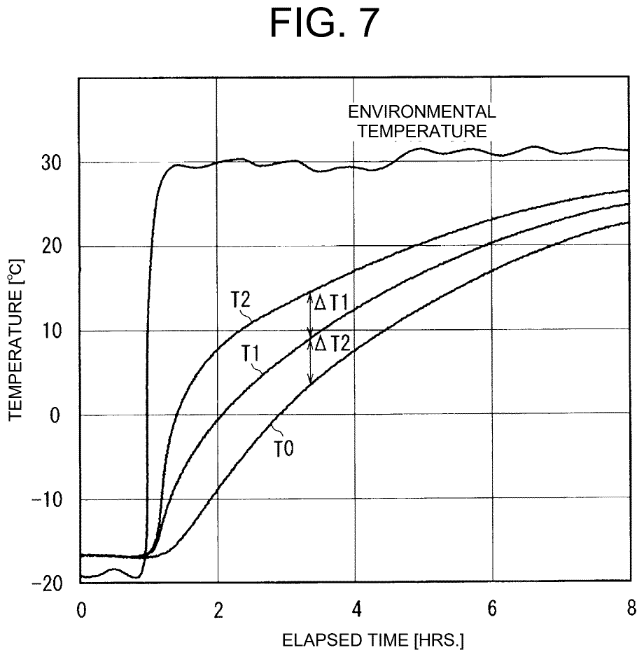

FIG. 7 is a graph illustrating time transition of a board temperature and a cell internal temperature when an environmental temperature is steeply changed. A horizontal axis of the graph represents elapsed time (hours), and a vertical axis represents temperature (C). The graph of FIG. 7 illustrates time transitions of a cell internal temperature T0, a coupling-portion temperature T1, and a board temperature T2 when the temperature of an environment in which the energy storage apparatus 1 is installed (environmental temperature) is steeply changed from −17° C. to 30° C. The above-described environment is an environment in which it is assumed that the energy storage apparatus 1 is mounted in a vehicle cabin, and when the vehicle cabin is warmed by a heater in winter, the energy storage apparatus 1 is warmed as the temperature of the vehicle cabin rises.

The cell internal temperature T0 represents an internal temperature of the energy storage device 2. In the present example embodiment, the cell internal temperature T0 is a temperature to be estimated by the management apparatus 100, but FIG. 7 illustrates a result of actually measuring an internal temperature of the first energy storage device 2A by experimentally using temperature sensors (not illustrated).

The coupling-portion temperature T1 represents temperature measured by the first temperature sensor TS11. That is, the coupling-portion temperature T1 represents a temperature of the coupling site on the circuit board 6 to which the bus bar 42 is coupled. Since the bus bar 42 is connected to the first energy storage device 2A and the second energy storage device 2B, the coupling-portion temperature T1 is a temperature reflecting the internal temperatures of the first energy storage device 2A and the second energy storage device 2B.

The board temperature T2 represents a temperature measured by the second temperature sensor TS20. That is, the board temperature T2 represents the ambient temperature of the circuit board 6.

The graph of FIG. 7 illustrates a state in which the cell internal temperature T0, the coupling-portion temperature T1, and the board temperature T2 change over time, following a steep change in the environmental temperature. That is, the board temperature T2 increases as heat outside the energy storage apparatus 1 is transferred to the circuit board 6 via the surrounding air. The coupling-portion temperature T1 increases as the heat transferred to the circuit board 6 is transferred to the coupling site via the inside of the board or the surface of the board. The cell internal temperature T0 increases as the heat transferred to the coupling site is transferred to the inside of the first energy storage device 2A via the bus bar 42 (heat transfer structure).

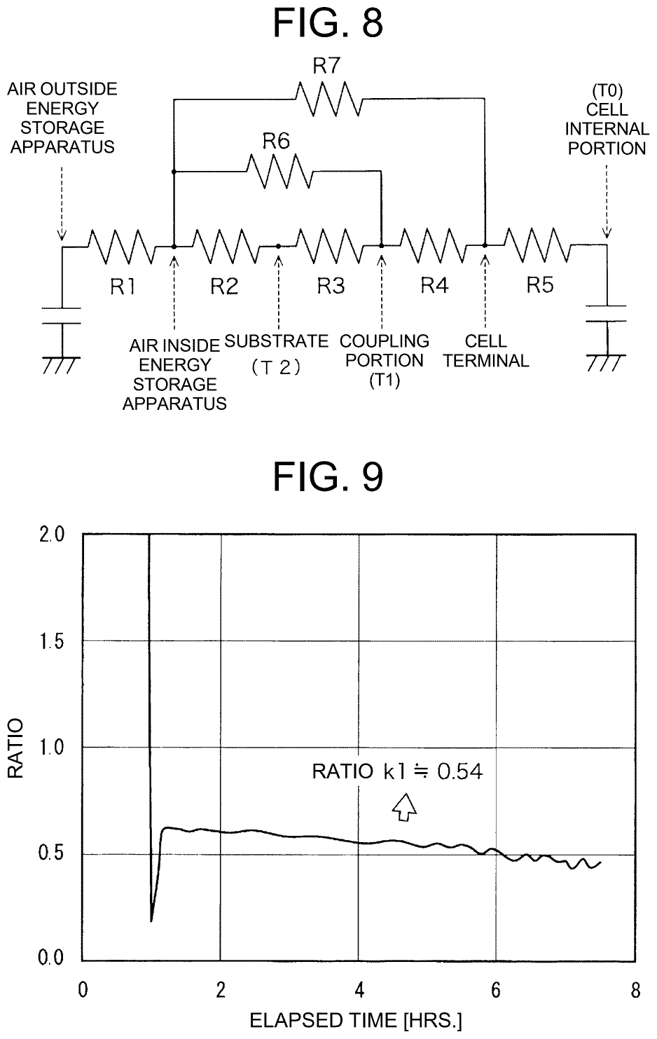

A transfer path through which heat outside the energy storage apparatus 1 is transferred to the first energy storage device 2A is described by a thermal circuit model. FIG. 8 is a circuit diagram representing a thermal circuit model of the energy storage apparatus 1. The thermal circuit model illustrated in FIG. 8 illustrates a heat transfer path from the outside of the energy storage apparatus 1 to the inside of the first energy storage device 2A. In the example of FIG. 8, a thermal resistance R1 represents a thermal resistance of a structure (the housing case 10) that separates air outside the energy storage apparatus 1 from air inside the energy storage apparatus 1. A thermal resistance R2 represents a thermal resistance of a transfer path through which heat transferred to the air inside the energy storage apparatus 1 is transferred to the circuit board 6. A thermal resistance R3 represents a thermal resistance of a transfer path through which the heat transferred to the circuit board 6 is transferred to the coupling sites of the bus bars 41 and 42. A thermal resistance R4 represents a thermal resistance of a transfer path through which the heat transferred to the coupling sites is transferred to the cell terminal via the bus bars 41 and 42. A thermal resistance R5 represents a thermal resistance of a transfer path through which the heat transferred to the cell terminal is transferred to the inside of the cell. A thermal resistance R6 represents a thermal resistance of a transfer path through which the heat transferred to the air inside the energy storage apparatus 1 is transferred to the coupling sites of the bus bars 41 and 42. A thermal resistance R7 represents a thermal resistance of a transfer path through which the heat transferred to the air inside the energy storage apparatus 1 is transferred to the cell terminal. When a heat generating component (semiconductor switch) provided on the circuit board 6 is considered, a thermal resistance to be connected in parallel to the thermal resistance R3 is added.

In general, heat is transferred by thermal conduction, convection, and thermal radiation, and a temperature difference occurs due to thermal resistance (difficulty in heat transfer). In a situation in which the environmental temperature rises, heat outside the energy storage apparatus 1 is transferred to the circuit board 6 by the housing case 10 and air inside the housing case 10. Since the thermal resistances R1 and R2 exist therebetween, the temperature of the circuit board 6 (board temperature T2) becomes lower than the environmental temperature. The heat transferred to the circuit board 6 is transferred to the coupling site via the inside of the board or the surface of the board. Since the thermal resistance R3 exists therebetween, the temperature of the coupling site (coupling-portion temperature T1) is lower than the board temperature T2. The heat transferred to the coupling site is transferred to the inside of the first energy storage device 2A via the bus bar 42 (heat transfer structure), the case 21 of the first energy storage device 2A, and the like. Since the thermal resistances R4 and R5 exist therebetween, the temperature inside the first energy storage device 2A (cell internal temperature T0) is lower than the coupling-portion temperature T1.

The inventors of the present invention have found that a ratio of a difference AT1 between the board temperature T2 and the coupling-portion temperature T1 to a difference AT2 between the coupling-portion temperature T1 and the cell internal temperature T0 is substantially constant regardless of the lapse of time. FIG. 9 is a graph illustrating a temporal change in the ratio. In the graph, a horizontal axis represents elapsed time (hours), and a vertical axis represents ratio. A ratio k1 is calculated by using the cell internal temperature T0, the coupling-portion temperature T1, and the board temperature T2 at each time, according to ΔT1/ΔT2=(T2−T1)/(T1−T0). As a result of calculating the ratio k1 for the first energy storage device 2A, the ratio k1 is a substantially fixed value (=0.54), except for a time range in which the environmental temperature steeply changes (a time range until the elapsed time has elapsed by approximately 1.2 hours).

Although FIGS. 7 to 9 illustrate a relationship between the internal temperature of the first energy storage device 2A (the cell internal temperature T0), and the coupling-portion temperature T1 and the board temperature T2, similar results have been also acquired for the relationship between the internal temperatures of the second energy storage device 2B to the fourth energy storage device 2D (the cell internal temperatures T0), and the coupling-portion temperature T1 and the board temperature T2.

For the second energy storage device 2B, a ratio k2 is calculated by ΔT1/ΔT2=(T2−T1)/(T1−T0). A transfer path through which heat outside the energy storage apparatus 1 is transferred to the second energy storage device 2B is different from a transfer path through which heat outside the energy storage apparatus 1 is transferred to the first energy storage device 2A, and the thermal resistances R3 to R5 are mainly different between the two. Therefore, even if the environmental temperature is uniform, the internal temperature of the second energy storage device 2B is different from the internal temperature of the first energy storage device 2A. The internal temperature (actual measurement value) of the second energy storage device 2B at each time is used as the cell internal temperature T0 when the ratio k2 is calculated. The internal temperature of the second energy storage device 2B is measured by a temperature sensor (not illustrated). As the coupling-portion temperature T1, a temperature at each time of the coupling site on the circuit board 6 to which the bus bar 42 is coupled is used. Alternatively, as the coupling-portion temperature T1, a temperature at each time of the coupling site on the circuit board 6 to which the bus bar 43 is coupled may be used. As the board temperature T2, an ambient temperature of the circuit board 6 at each time is used.

For the third energy storage device 2C, a ratio k3 is calculated by ΔT1/ΔT2=(T2−T1)/(T1−T0). A transfer path through which heat outside the energy storage apparatus 1 is transferred to the third energy storage device 2C is different from a transfer path through which heat outside the energy storage apparatus 1 is transferred to the first energy storage device 2A or the second energy storage device 2B, and the thermal resistances R3 to R5 are mainly different between the two. Therefore, even if the environmental temperature is uniform, the internal temperature of the third energy storage device 2C is different from the internal temperatures of the first energy storage device 2A and the second energy storage device 2B. The internal temperature (actual measurement value) of the third energy storage device 2C at each time is used as the cell internal temperature T0 when the ratio k3 is calculated. The internal temperature of the third energy storage device 2C is measured by a temperature sensor (not illustrated). As the coupling-portion temperature T1, a temperature at each time of the coupling site on the circuit board 6 to which the bus bar 43 is coupled is used. Alternatively, a temperature at each time of the coupling site on the circuit board 6 to which the bus bar 44 is coupled may be used as the coupling-portion temperature T1. As the board temperature T2, an ambient temperature of the circuit board 6 at each time is used.

For the fourth energy storage device 2D, a ratio k4 is calculated by ΔT1/ΔT2=(T2−T1)/(T1−T0). A transfer path through which heat outside the energy storage apparatus 1 is transferred to the fourth energy storage device 2D is different from a transfer path through which heat outside the energy storage apparatus 1 is transferred to the first energy storage device 2A to the third energy storage device 2C, and the thermal resistances R3 to R5 are mainly different between the two. Therefore, even if the environmental temperature is uniform, the internal temperature of the fourth energy storage device 2D is different from the internal temperatures of the first energy storage device 2A to the third energy storage device 2C. The internal temperature (actual measurement value) of the fourth energy storage device 2D at each time is used as the cell internal temperature T0 when the ratio k4 is calculated. The internal temperature of the fourth energy storage device 2D is measured by a temperature sensor (not illustrated). As the coupling-portion temperature T1, a temperature at each time of the coupling site on the circuit board 6 to which the bus bar 44 is coupled is used. As the board temperature T2, an ambient temperature of the circuit board 6 at each time is used.

In the present example embodiment, in a learning phase before an actual operation of the energy storage apparatus 1 is started, the internal temperature T0, the coupling-portion temperature T1, and the board temperature T2 of each of the first energy storage device 2A to the fourth energy storage device 2D are measured, and the ratios k1 to k4 are calculated in advance. The calculated ratios k1 to k4 are stored in the storage section 102 of the management apparatus 100. In an operation phase after an actual operation of the energy storage apparatus 1 is started, the arithmetic section 101 of the management apparatus 100 reads the ratios k1 to k4 from the storage section 102, and measures the coupling-portion temperature T1 and the board temperature T2, thereby estimating the internal temperature T0 of each of the first energy storage device 2A to the fourth energy storage device 2D. That is, the arithmetic section 101 estimates the internal temperature T0 of each of the first energy storage device 2A to the fourth energy storage device 2D, based on the temperatures of the coupling sites measured by the first temperature sensors TS11 to TS13.

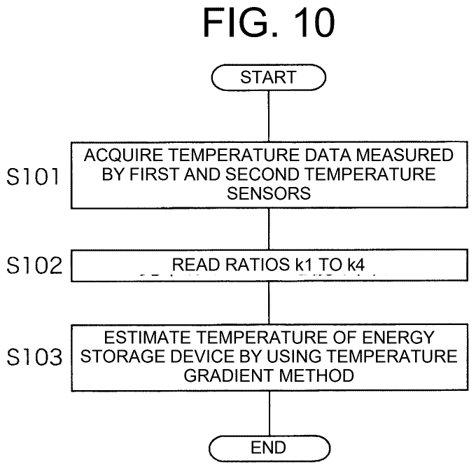

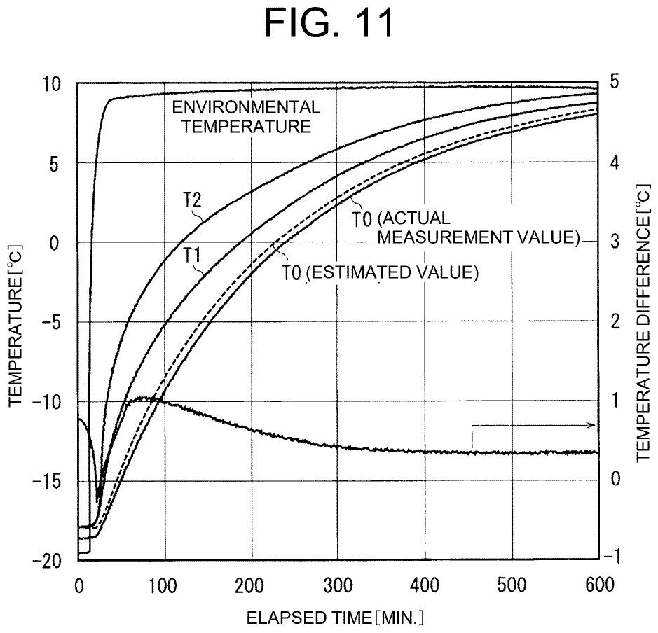

FIG. 10 is a flowchart illustrating a procedure of processing to be executed by the management apparatus 100 according to the first example embodiment. It is assumed that, for the first energy storage device 2A to the fourth energy storage device 2D, the ratios k1 to k4 are calculated in advance and stored in the storage section 102.

The arithmetic section 101 of the management apparatus 100 acquires, through the communication section 103, the temperature data measured by the first temperature sensors TS11 to TS13 and the temperature data measured by the second temperature sensor TS20 (step S101).

The arithmetic section 101 reads the ratios k1 to k4 from the storage section 102 (step S102). The processing in step S101 and step S102 may be executed in a different order, or may be executed simultaneously in parallel.

The arithmetic section 101 estimates the internal temperatures of the first energy storage device 2A to the fourth energy storage device 2D by using a temperature gradient method (step S103). To be more specific, the arithmetic section 101 estimates the internal temperatures (=T0) of the first energy storage device 2A to the fourth energy storage device 2D by using a relational equation of (T2−T1)/(T1−T0)=k1 (or k2 to k4).

FIG. 11 is a graph illustrating an estimation result in the first example embodiment. In the graph, a horizontal axis represents elapsed time (minutes), a left scale of a vertical axis represents temperature (° C.), and a right scale thereof represents temperature difference (° C.). T1 is, for example, the coupling-portion temperature measured by the temperature sensor TS11, and indicates a temperature change when the environmental temperature is steeply changed. T2 is the board temperature measured by the temperature sensor TS20, and indicates a temperature change when the environmental temperature is steeply changed.

T0 (estimated value) indicates a value of the internal temperature of the first energy storage device 2A, which is estimated by using the temperature gradient method, based on the coupling-portion temperature T1, the board temperature T2, and the ratio k1. T0 (actual measurement value) shown for reference indicates an actual measurement value of the internal temperature of the first energy storage device 2A, which is measured by a sensor (not illustrated).

As a result of the estimation, a temperature difference between T0 (estimated value) and T0 (actual measurement value) has been approximately 1.2° C. at maximum and approximately 0.5° C. on average. Although the example of FIG. 11 illustrates the temperature estimation result of the first energy storage device 2A, similar temperature estimation results have been acquired for the second energy storage device 2B to the fourth energy storage device 2D.

As described above, in the first example embodiment, the temperature of the energy storage device 2 can be estimated based on the temperatures of the coupling sites measured by the first temperature sensors TS11 to TS13 provided on the circuit board 6. Compared to a case in which temperature sensors are attached to surfaces of energy storage devices, the first temperature sensors TS11 to TS13 can be easily attached to the circuit board 6, and no special attachment structure is necessary. As the first temperature sensors TS11 to TS13 provided on the circuit board 6, small and inexpensive chip thermistors or the like can be used, which can contribute to miniaturization and cost reduction of the energy storage apparatus 1.

In the first example embodiment, the temperatures of the first energy storage device 2A to the fourth energy storage device 2D are estimated by using the three first temperature sensors TS11 to TS13. Alternatively, the temperatures of the first energy storage device 2A to the fourth energy storage device 2D may be estimated by using the two first temperature sensors TS11 and TS13. Since the temperature of the coupling site measured by the first temperature sensor TS11 reflects the temperatures of the first energy storage device 2A and the second energy storage device 2B, it is possible to estimate the temperatures of the first energy storage device 2A and the second energy storage device 2B by using a measurement value of the first temperature sensor TS11. Since the temperature of the coupling site measured by the first temperature sensor TS13 reflects the temperatures of the third energy storage device 2C and the second energy storage device 2D, the temperatures of the third energy storage device 2C and the fourth energy storage device 2D can be estimated by using a measurement value of the first temperature sensor TS13. In this case, the first temperature sensor TS12 may not be mounted on the circuit board 6, and the bus bar 43 may not be coupled to the circuit board 6.

In a second example embodiment, an estimation result in a case where first temperature sensors TS11 to TS13 are disposed at proximity sites close to energy storage devices 2 on a heat transfer structure will be described.

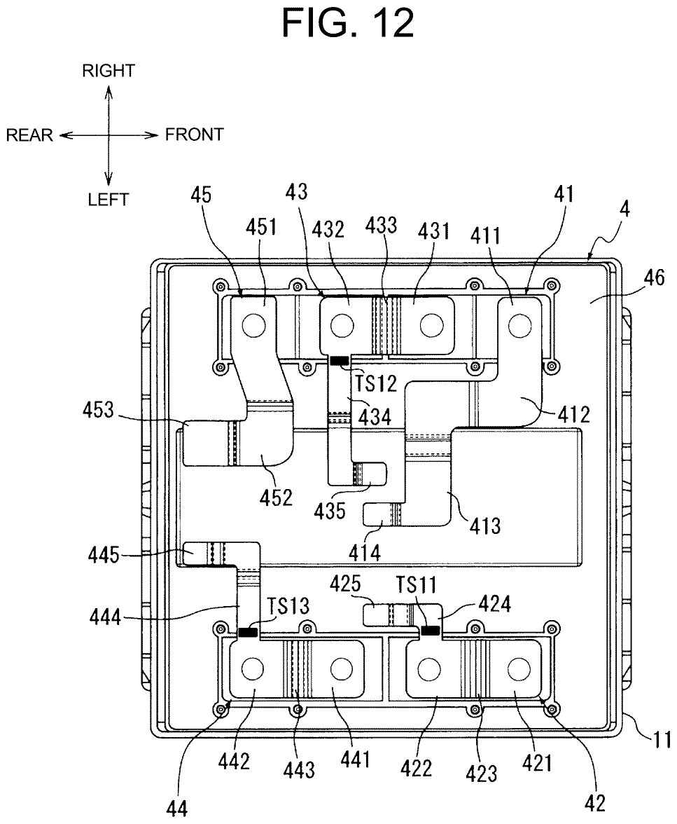

FIG. 12 is an explanatory view illustrating an arrangement of the first temperature sensors TS11 to TS13 in the second example embodiment. In FIG. 12, for the sake of description, an upper surface of a bus bar unit 4 is illustrated in a state in which a circuit board 6 is removed.

The first temperature sensor TS11 measures a temperature of a proximity site close to a first energy storage device 2A and a second energy storage device 2B on a bus bar 42. The proximity site represents a position to which heat of the first energy storage device 2A and the second energy storage device 2B is transferred and which is detected as a temperature change on the bus bar 42. The proximity site represents a position closer to the first energy storage device 2A and the second energy storage device 2B than a site where the temperature is measured by a second temperature sensor TS20. The first temperature sensor TS11 is disposed, for example, at a position closer to a second base portion 422 of a bent portion 424. Alternatively, the first temperature sensor TS11 is disposed on an upper surface of a first base portion 421 or the second base portion 422.

The first temperature sensor TS12 measures a temperature of a proximity site close to the second energy storage device 2B and a third energy storage device 2C on a bus bar 43. The proximity site represents a position to which heat of the second energy storage device 2B and the third energy storage device 2C is transferred and which is detected as a temperature change on the bus bar 43. The proximity site represents a position closer to the second energy storage device 2B and the third energy storage device 2C than a site where the temperature is measured by the second temperature sensor TS20. The first temperature sensor TS12 is disposed, for example, at a position closer to a second base portion 432 of a bent portion 434. Alternatively, the first temperature sensor TS12 is disposed on an upper surface of a first base portion 431 or the second base portion 432.

The first temperature sensor TS13 measures a temperature of a proximity site close to the third energy storage device 2C and a fourth energy storage device 2D on a bus bar 44. The proximity site represents a position to which heat of the third energy storage device 2C and the fourth energy storage device 2D is transferred and which is detected as a temperature change on the bus bar 44. The proximity site represents a position closer to the third energy storage device 2C and the fourth energy storage device 2D than a site where the temperature is measured by the second temperature sensor TS20. The first temperature sensor TS12 is disposed, for example, at a position closer to a second base portion 442 of a bent portion 444. Alternatively, the first temperature sensor TS12 is disposed on an upper surface of a first base portion 441 or the second base portion 442.

In the second example embodiment, as in the first example embodiment, in a learning phase before an actual operation of an energy storage apparatus 1 is started, an internal temperature T0, a proximity-portion temperature T1, and a board temperature T2 of each of the first energy storage device 2A to the fourth energy storage device 2D are measured, and ratios k1 to k4 are calculated in advance. Herein, the proximity-portion temperature T1 is a temperature to be measured instead of the coupling-portion temperature T1 in the first example embodiment, and is measured by the first temperature sensors TS11 to TS13 disposed at the proximity sites of the first energy storage device 2A to the fourth energy storage device 2D. The calculated ratios k1 to k4 are stored in a storage section 102 of a management apparatus 100. In an operation phase after an actual operation of the energy storage apparatus 1 is started, an arithmetic section 101 of the management apparatus 100 reads the ratios k1 to k4 from the storage section 102, and measures the proximity-portion temperature T1 and the board temperature T2, thereby estimating the internal temperature T0 of each of the first energy storage device 2A to the fourth energy storage device 2D.

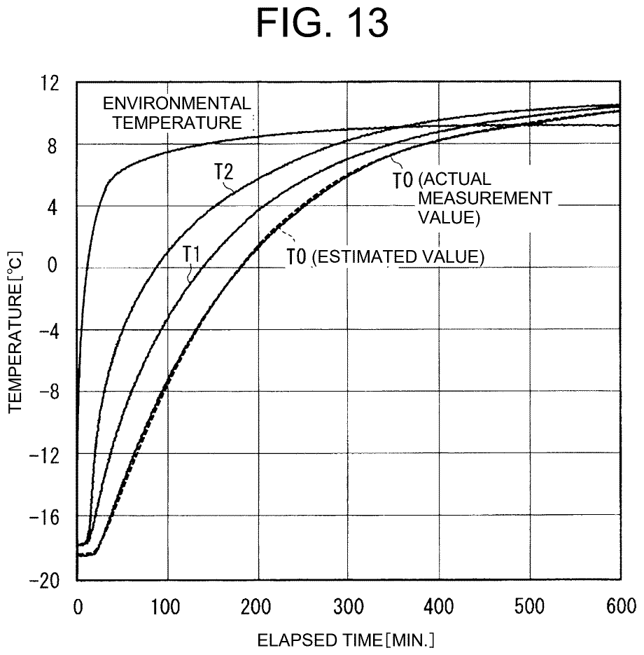

FIG. 13 is a graph illustrating an estimation result in the second example embodiment. A horizontal axis of the graph represents elapsed time (minutes), and a vertical axis represents temperature (° C.). T1 is, for example, the proximity-portion temperature measured by the temperature sensor TS11, and indicates a temperature change when an environmental temperature is steeply changed. T2 is the board temperature measured by the temperature sensor TS20, and indicates a temperature change when the environmental temperature is steeply changed.

T0 (estimated value) indicates a value of an internal temperature of the first energy storage device 2A, which is estimated by using a temperature gradient method, based on the proximity-portion temperature T1, the board temperature T2, and the ratio k1. T0 (actual measurement value) shown for reference indicates an actual measurement value of the internal temperature of the first energy storage device 2A, which is measured by a sensor (not illustrated).

As a result of the estimation, it has been found that T0 (estimated value) reproduces T0 (actual measurement value) very well. Although the example of FIG. 11 illustrates a temperature estimation result of the first energy storage device 2A, similar estimation results have been acquired for the second energy storage device 2B to the fourth energy storage device 2D.

As described above, in the second example embodiment, a temperature gradient method is applied using the proximity-portion temperature, thereby making it possible to accurately estimate the internal temperatures of the first energy storage device 2A to the fourth energy storage device 2D.

In the second example embodiment, the internal temperature of each energy storage device 2 is estimated by a temperature gradient method using the proximity-portion temperature T1 and the board temperature T2. Alternatively, the internal temperature of each energy storage device 2 may be estimated by a temperature gradient method using the proximity-portion temperature T1 and a cell top surface temperature. Here, the cell top surface temperature represents a temperature of an upper surface (top surface) of a case 21. The cell top surface temperature has a value close to that of the internal temperature of each energy storage device 2, but does not completely coincide therewith, and therefore, accurate internal when highly temperature estimation is necessary, an estimation method using the temperature gradient method is effective.

Alternatively, temperatures of any two points having a temperature gradient from the inside of the energy storage device may be measured, and the internal temperature of each energy storage device 2 may be estimated by using a temperature gradient method. In a case of a large cell, a temperature gradient is likely to occur, and therefore the temperature gradient method is effective. For example, in an energy storage apparatus of an electric vehicle with increased capacity, an internal temperature of the energy storage apparatus can be estimated by using the temperature gradient method. The estimated internal temperature is used, for example, when predicting a cruising distance at a low temperature. The temperature gradient method is also effective when the environmental temperature is likely to change, such as in a vehicle or an external energy storage facility. The estimated internal temperature is used, for example, when predicting a cruising distance at a low temperature in a high-rate vehicle such as an HEV or a PHEV.

In a third example embodiment, a configuration will be described in which, when a heat generating component disposed on a circuit board 6 generates heat, a temperature of an energy storage device 2 is estimated by a method (second method) based on a current that flows through the energy storage device 2, instead of a temperature gradient method (first method). Hereinafter, the method (second method) based on the current that flows through the energy storage device 2 is also referred to as a Joule heating method.

Since a configuration of an energy storage apparatus 1 and an internal configuration of a management apparatus 100 are similar to those in the first example embodiment, description thereof will be omitted.

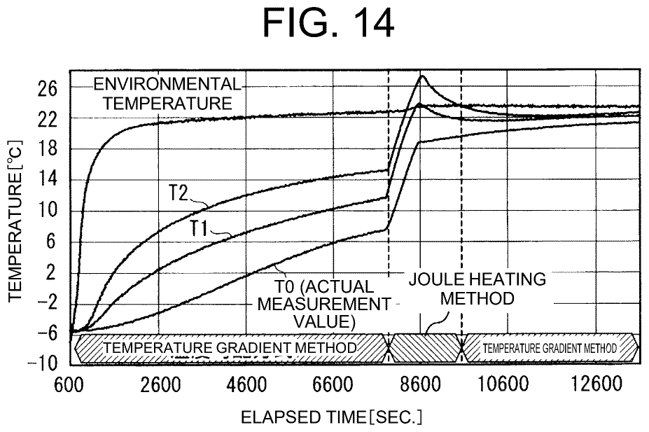

FIG. 14 is an explanatory view illustrating a timing of switching between the temperature gradient method and the Joule heating method. In the graph illustrated in FIG. 14, a horizontal axis represents elapsed time (seconds), and a vertical axis represents temperature (° C.). The graph of FIG. 14 illustrates temperature changes of a board temperature T2, a coupling-portion temperature T1, and a cell internal temperature T0 in a case where an environmental temperature steeply changes when an elapsed time is around 600 seconds, and the heat generating component generates heat due to a flow of current from the energy storage device 2 when the elapsed time is around 7900 seconds. The board temperature T2 is a temperature measured by a temperature sensor TS20, and the coupling-portion temperature T1 is, for example, a temperature measured by a temperature sensor TS11. The cell internal temperature T0 is an internal temperature (actual measurement value) of a first energy storage device 2A, which is measured by a temperature sensor (not illustrated).

During a time period when there is no influence of heat from the heat generating component, a ratio of a difference between the board temperature T2 and the coupling-portion temperature T1 to a difference between the coupling-portion temperature T1 and the cell internal temperature T0 is substantially constant. During these time periods, the management apparatus 100 estimates the internal temperature of each energy storage device 2 by applying the above-described temperature gradient method. In the example of FIG. 14, the temperature gradient method is applied during a time period in which the elapsed time is 600 to 7900 seconds and a time period in which the elapsed time is 9600 seconds onwards.

On the other hand, during a time period when there is an influence of heat from the heat generating component, the ratio of the difference between the board temperature T2 and the coupling-portion temperature T1 and the difference between the coupling-portion temperature T1 and the cell internal temperature T0 is not necessarily constant. When the temperature gradient method is applied during this time period, the accuracy of temperature estimation may decrease. Therefore, the management apparatus 100 according to the third example embodiment switches from the temperature gradient method to the method based on a current that flows through the energy storage device 2 (Joule heating method) during the time period when there is an influence of heat from the heat generating component, and estimates the internal temperature of each energy storage device 2. In the example of FIG. 14, the Joule heating method is applied during a time period when the elapsed time is 7900 to 9600 seconds.

In the Joule heating method, a temperature change ΔT is calculated by the following equation.

ΔT=(Qp+Qs+Qb)/C×Δt

Qp represents heat generation (Joule heat) caused by a resistance component inside the energy storage device 2 during energization. An arithmetic section 101 of the management apparatus 100 calculates the Joule heat Qp by (cell voltage measurement value (V)−OCV(V))×current measurement value (A). The cell voltage measurement value and the current measurement value are measured by a voltage sensor and a current sensor, which are not illustrated. The open circuit voltage (OCV) is given, for example, as a function of state of charge (SOC).

Qs represents heat absorption/generation (reaction heat) due to an entropy change during charge/discharge. The arithmetic section 101 calculates the reaction heat Qs by cell temperature estimated value (K)×ΔS (J/mol K)×current measurement value (A)/Faraday constant (C/mol). ΔS is given, for example, as a function of SOC.

Qb represents heat dissipation from a heat source to the surroundings. The arithmetic section 101 calculates a heat dissipation Qb by (environmental temperature estimated value (° C.)−cell temperature estimated value (° C.))/thermal resistance (° C./W). The thermal resistance is a constant that does not change depending on the temperature, and is assumed to be measured in advance. C is a heat capacity of the energy storage device 2, and Δt is an energization time.

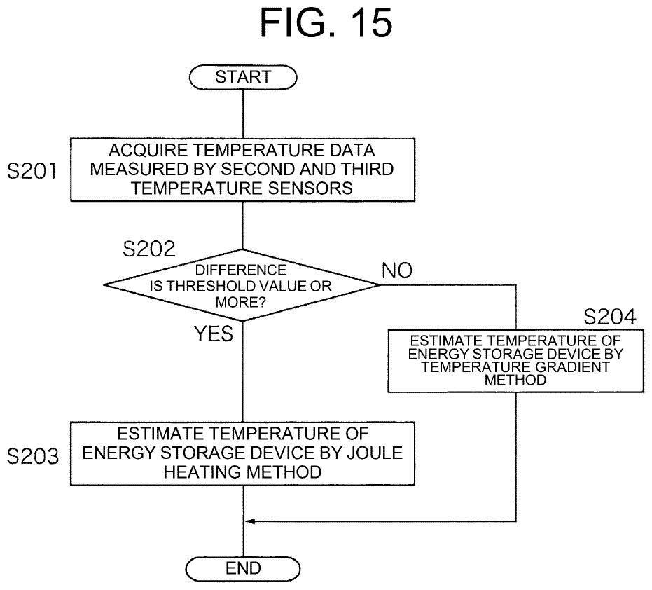

FIG. 15 is a flowchart illustrating a procedure of processing to be executed by the management apparatus 100 according to the third example embodiment. The arithmetic section 101 of the management apparatus 100 acquires, through a communication section 103, temperature data measured by the second temperature sensor TS20 and temperature data measured by a third temperature sensor TS30 (step S201). The arithmetic section 101 executes the following processing every time the temperature data measured by the second temperature sensor TS20 and the temperature data measured by the third temperature sensor TS30 are acquired.

The arithmetic section 101 determines whether or not a difference between a temperature of the heat generating component and the board temperature T2 is greater than or equal to a threshold value (step S202). In the present example embodiment, the heat generating component is a semiconductor switch included in a blocking circuit 61. The threshold value is, for example, 3° C.

When it is determined that the difference between the temperature of the heat generating component and the board temperature T2 is greater than or equal to the threshold value (S202: YES), the arithmetic section 101 estimates the temperature of the energy storage device 2 by the Joule heating method (step S203). The arithmetic section 101 estimates the temperature of the energy storage device 2 by calculating a temperature change AT of the energy storage device 2 by using the equation ΔT=(Qp+Qs+Qb)/C×Δt.

When it is determined that the difference between the temperature of the heat generating component and the board temperature T2 is less than the threshold value (S202: NO), the arithmetic section 101 estimates the temperature of the energy storage device 2 by the temperature gradient method (step S204). A temperature estimation method for the energy storage device 2 using the temperature gradient method is the same as that in the first example embodiment. That is, the arithmetic section 101 acquires, through the communication section 103, temperature data measured by first temperature sensors TS11 to TS13 and the temperature data measured by the second temperature sensor TS20, and executes calculation using ratios k1 to k4, thereby estimating internal temperatures of the first energy storage device 2A to a fourth energy storage device 2D.

As described above, in the third example embodiment, when the temperature of the heat generating component is higher than or equal to the threshold value, the temperature of the energy storage device 2 is estimated by switching the method to the Joule heating method, and therefore, the temperature of the energy storage device 2 can be estimated accurately regardless of the operating state of the energy storage apparatus 1.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage device;
a circuit board thermally separated from the energy storage device;
a heat transfer structure made of metal to transfer heat of the energy storage device to the circuit board;
a first temperature sensor provided on the circuit board to be electrically insulated from a coupling site on the circuit board to which the heat transfer structure is coupled and to measure a temperature of the coupling site; and
an arithmetic device including a processor and a memory, the memory including a program that is executable by the processor to cause the processor to estimate a temperature of the energy storage device based on the temperature of the coupling site measured by the first temperature sensor.

2. The energy storage apparatus according to claim 1, further comprising:
a bus bar defining a charge/discharge path of the energy storage device; wherein
the heat transfer structure is integral with the bus bar.

3. The energy storage apparatus according to claim 2, wherein the heat transfer structure has a smaller cross-sectional area than that of the bus bar, and extends from the bus bar toward the circuit board.

4. The energy storage apparatus according to claim 2, further comprising:
a plurality of energy storage devices electrically connected to each other by the bus bar; wherein
the heat transfer structure is configured to transfer heat of the plurality of energy storage devices to the circuit board.

5. The energy storage apparatus according to claim 1, wherein the arithmetic device is configured or programmed to estimate a temperature of the energy storage device by switching between a first method based on a temperature of the coupling site and a second method based on a current that flows through the energy storage device.

6. The energy storage apparatus according to claim 5, further comprising:
a heat generating component provided on the circuit board;
a third temperature sensor to measure a temperature of the heat generating component; wherein
the arithmetic device is configured or programmed to estimate the temperature of the energy storage device by the first method when a difference between the temperature of the heat generating component and a temperature of the circuit board is less than a threshold value, and to estimate the temperature of the energy storage device by the second method when the difference is greater than or equal to the threshold value.

7. The energy storage apparatus according to claim 1, further comprising:
a storage section to store data; and
a second temperature sensor to measure a temperature of the circuit board; wherein
in a learning phase before an actual operation of the energy storage apparatus, the arithmetic device is configured or programmed to measure an internal temperature of the energy storage device before the actual operation, the temperature of the coupling site before the actual operation, and the temperature of the circuit board before the actual operation, and to calculate in advance a ratio based on the internal temperature of the energy storage device before the actual operation, the temperature of the coupling site before the actual operation, and the temperature of the circuit board before the actual operation, and to store the ratio in the storage section; and
in an operation phase after the actual operation of the energy storage apparatus, the arithmetic device is configured or programmed to read the ratio stored in the storage section, and estimate the internal temperature of the energy storage device based on the ratio, the temperature of the coupling site, and the temperature of the circuit board.

8. A management apparatus comprising:
a processor;
a memory including a program executable by the processor to function as:
an acquisition section configured or programmed to acquire, from a temperature sensor, temperature data of a coupling site on a circuit board to which a heat transfer structure is coupled, the circuit board being thermally separated from an energy storage device, the heat transfer structure being configured to transfer heat of the energy storage device to the circuit board, the temperature sensor being provided on the circuit board to be electrically insulated from the coupling site and to measure a temperature of the coupling site; and
an estimation section configured or programmed to estimate a temperature of the energy storage device based on the acquired temperature data.

9. A temperature estimation method for an energy storage device, the temperature estimation method causing a computer to perform processing including:
acquiring, from a temperature sensor, temperature data of a coupling site on a circuit board to which a heat transfer structure is coupled, the circuit board being thermally separated from an energy storage device, the heat transfer structure transferring heat of the energy storage device to the circuit board, the temperature sensor being provided on the circuit board to be electrically insulated from the coupling site and to measure a temperature of the coupling site; and
estimating a temperature of the energy storage device based on the temperature data acquired in the acquiring.

10. A non-transitory computer-readable medium including a computer program executable to cause a computer to perform processing including:
acquiring, from a temperature sensor, temperature data of a coupling site on a circuit board to which a heat transfer structure is coupled, the circuit board being thermally separated from an energy storage device, the heat transfer structure transferring heat of the energy storage device to the circuit board, the temperature sensor being provided on the circuit board to be electrically insulated from the coupling site and to measure a temperature of the coupling site; and
estimating a temperature of the energy storage device based on the temperature data acquired in the acquiring.
